(19) United States
(12) Patent Application Publication
(10) Pub. No.: US 2011/0107605 A1
(43) Pub. Date: May 12, 2011

(54) STRUCTURE OF SCISSORS

(76) Inventor: SHIH-CHIEH HUNG, Xindian City (TW)

(21) Appl. No.: 12/899,536

(22) Filed: Oct. 6, 2010

(30) Foreign Application Priority Data
Nov. 12, 2009 (TW) 098138393

(51) Int. Cl. B26B 13/22

(52) U.S. Cl. 30/244

(57) ABSTRACT

A structure of scissors includes a body and two elastic elements. The body includes two blades at one side of a pivot for opening and closing with respect to each other and two holding sections at an opposite side of the pivot for driving movement of the blades about the pivot for opening and closing the scissors. Each of the two holding sections has two ends each forming a connection section to allow the two holding sections of the body to be connected to coupling sections formed on ends of the two elastic elements, whereby the two elastic elements and the two holding sections form finger holes for receiving fingers to be positioned therein for operating the two blades to open and close. As such, easy operation of the scissors can be realized for swinging and waving and reducing the reaction forces acting on the fingers.

### (a) TECHNICAL FIELD OF THE INVENTION

The present invention provides an improved structure of scissors, and in particular to a structure of scissors that allows for swinging and waving in any direction, wherein through elastic elements mounted to two holding section of a body of the scissors, two blades of the body are allow to do smooth shaking and reaction forces acting on fingers are reduced.

### (b) DESCRIPTION OF THE PRIOR ART

Tools are often used in daily living or offices for assisting the performance of various operations or jobs. For example, cutting of paper or cloth, or cutting of hair, is often performed with a pair of scissors that is used to carry out operations of shearing and cutting. In using scissors, a user puts his or her fingers in through holes formed in handles of scissors for driving blades of the scissors to performed desired operations of opening and closing. The handles of the scissors are rigid. Fingers are put into the through holes of the handles for driving the blades, where the handles and the fingers are set in inclined engagement with respect to each other, whereby when the fingers are operating the scissors, the handles induce reaction forces acting on the fingers, which may depress or compress the fingers and lead to the formation of callus after a long time of use, making the skin of finger rough.

Using a pair of scissors to cut hair requires various hand posture, skills and control in the process of hair cutting in order to properly operate the scissors. A hair stylist often relies on his or her personal experience and skills to complete the hair cutting operation for various hair dos. Thus, the hair cutting scissors are of vital importance for the hair stylist in making a desired hair do. With various skills of operating the scissors, various fashions of hair in relation to thickness, multiple layer, elegancy, and beautifulness can be made through for example perpendicular cutting, slide cutting, and fly cutting. In performing fly cutting, the hair stylist must uses his or her fingers, wrist, elbow for applying forces to move the scissors up and down, left and right for swinging, shaking, and waving of the scissors. For large distance movement, the fingers and wrist are often subjected to significant twisting and rotation. For a known pair of scissors, of which the structure is shown in FIG. 10, is composed of a first blade A and a second blade B. The first blade A and the second blade B cross each other and is pivotally jointed through a pivot pin C at the intersection thereof to allow the first blade A and the second blade B to open and close with respect to each other. One side of each of the first blade A and the second blade B forms, in an integrated form, a finger hole D for receiving a finger of a user to be positioned therein. The user puts his or her fingers in the finger holes D for driving movement of the first blade A and the second blade B for opening and closing in order to carry out hair cutting. This often leads to twisting of fingers. Further, in cutting hair, the finger holes D of the first blade A and the second blade B induce reaction forces on the fingers, leading to impact, abrasion, and twisting. These causes damages of for example pains, soreness, callusing on the fingers. Also, various drawbacks are observed in the operation of the conventional scissors, such as:

(1) The first blade A and the second blade B integrally form finger holes D therein and the finger holes D have rigid circumferences, so that when fingers are put in the finger holes, the fingers are depressed or compressed and reaction forces are induced on the fingers when the finger apply force, leading to easy damage of the fingers.

(2) In the operation of scissors, it often requires to move the scissors in different ways of shaking and waving. This often causes the finger holes D to slide along the fingers, thereby inducing abrasion and impact with respect to the fingers, as well as jamming, making the operation of the scissors unsmooth.

Thus, it is a major challenge for the manufacturers of scissors to overcome the problems of severe impact and abrasion induced on fingers by finger holes due to the integral structure of the conventional scissors, as well as the problem of unsmooth operation occurring in the conventional scissors.

### SUMMARY OF THE INVENTION

In view of the above described, the present invention aims to provide a structure of scissors that features of elastic expandability of the finger holes that offers a function of cushioning in order to overcome the problem of damage induced on an operator of the scissors.

An objective of the present invention is to provide a structure of scissors, which comprises a body that comprises two blades at one side of a pivot and two holding sections at the opposite sides. Each of the two holding sections has two ends each forming a connection section for connection with coupling sections formed on two ends of each of two elastic elements, whereby the two elastic elements and the two holding sections form operating portions that receive fingers to insert therein for driving the two blades to open and close so as to realize operation of the scissors in shaking and waving and to reduce the reaction forces acting on the fingers.

Another objective of the present invention is to provide a structure of scissors that comprises a body comprising two holding sections, each being in the form of half a circle, a third of circle, a quarter of a circle, or other arcs and curves according to the desired use and for coupling with elastic elements having a desired length so as to define finger holes that are suitable for receiving different fingers therein.

A further objective of the present invention is to provide a structure of scissors that comprises a body having two holding sections, each having two ends forming connection sections, which are of a structure of assembling in the form of raised pillar, internal threading or external threading, clamping projections, for connection with coupling sections formed in ends of two elastic elements. The ends of the two elastic elements form connection sections corresponding to the two holding sections and forming a structure of assembling in the form of engaging recesses, external threading or internal threading, or fitting slots, for connection with the connection section.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a structure of scissors according to an embodiment of the present invention.

FIG. 2 is an exploded view of the structure of scissors according to the present invention.

FIG. 3 is a perspective view demonstrating leftward and rightward swinging of a body of the scissors according to the present invention.

FIG. 4 is a perspective view demonstrating upward and downward swinging of the body of the scissors according to the present invention.

FIG. 5 is an end view demonstrating swinging of elastic elements of the scissors according to the present invention.

FIG. 6 is an exploded view of a structure of scissors according to a preferred embodiment of the present invention.

FIG. 7 is an exploded view of a structure of scissors according to a further embodiment of the present invention.

FIG. 8 is a plan view of a structure of scissors according to a further embodiment of the present invention.

FIG. 9 is a plan view of a structure of scissors according to a further embodiment of the present invention.

FIG. 10 is a perspective view showing a conventional structure of scissors.

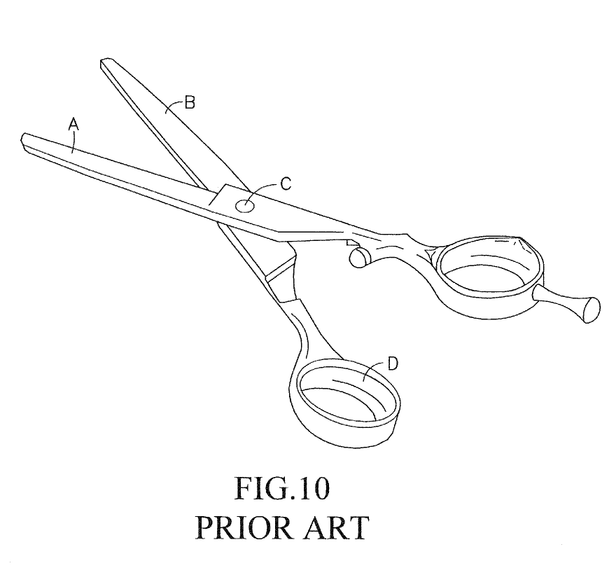

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

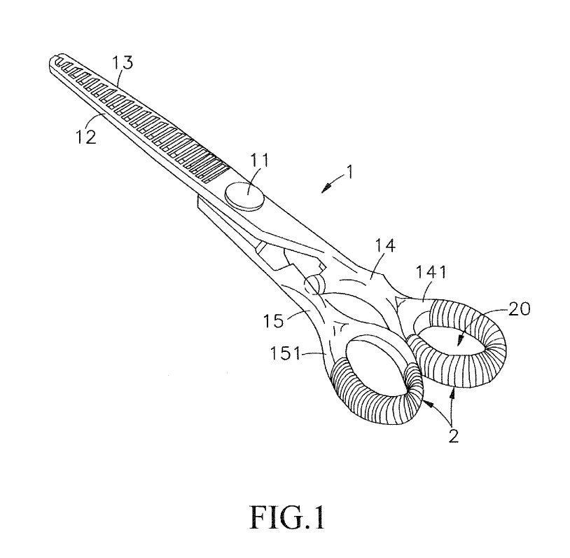

Referring to FIGS. 1, 2, and 3, which are respectively a perspective view and an exploded view of a structure of scissors according to the present invention and a perspective view demonstrating leftward and rightward swinging of a body of the scissors according to the present invention, these drawings show that the structure of scissors according to the present invention comprises a body 1 and two elastic elements 2.

The body 1 of the scissors comprises two blades 12, 13 extending from one side of a pivot 11 and two handles 14, 15 extending from an opposite side of the pivot 11. Further extending from the two handles 14, 15 in a direction away from the pivot are two arc holding sections 141, 151. Each of the two holding sections 141, 151 has two ends each forming a connection section 16.

The two elastic elements 2 are elastic bodies possessing resilient expandability and stretchability, and each has two ends each forming a coupling section 21.

To assemble, the two holding sections 141, 151 located at one side of the pivot 11 of the body 1 are coupled, with the connection sections 16 at two ends of each of the holding sections, to the coupling sections 21 formed at two ends of the respective elastic elements, whereby the two holding sections 141, 151 and the two elastic elements 2 form two enclosed, internal spaces that define two finger holes 20 for receiving fingers 3 to fit therein. In other words, fingers 3 can be put into the two finger holes 20 for selectively moving the two holding sections 141, 151 and the two elastic elements 2, so that the two holding sections 141, 151 may drive relative opening and closing movements of the two blades 12, 13 through rotation about the pivot 11 by the two handles 14, 15, in order to carry out shearing and cutting operations. This completes a structure of scissors according to the present invention.

The two holding sections 141, 151 of the body 1 are each provided with the coupling sections 16 for mating and connection with the coupling sections 21 of the two elastic elements 2, so that the holding sections 141, 151 and the elastic elements 2 form therebetween two finger holes 20 for receiving therein fingers 3. Further, through the variability of length or expandability of the two elastic elements 2, adjustability can be realized on the size of the two finger holes 20 formed between the elastic elements 2 and the two holding sections 141, 151 to suit for the needs of different applications or for receiving fingers 3 of different uses that are of different sizes and shape. Further, the two elastic elements 2 defining outside portions of the two finger holes 20 provide elastic expandability so that when fingers are positioned inside the two finger holes 20 to apply a force for moving the two elastic elements 2 and the two holding sections 141, 151, which further drives, through rotation about the pivot 11 by the two handles 14, 15, the two blades 12, 13 to open and close, reaction forces induced by shearing operations of the two blades 12, 13 are transmitted back to the two holding sections 141, 151 and the two elastic elements 2 and are damped by elastic expandability and stretchability of the two elastic elements 2 to have the reaction forces of the two blades 12, 13 canceled and thus realize the function of cushioning that protects the fingers 3 positioned in the two finger holes 20 from compression, impact, and/or abrasion caused by the reaction forces. Thus, damage and callusing occurring on the fingers 3 can be reduced and the elastic expandability of the two elastic elements 2 also helps improving smooth swinging and waving of the body 1 in carrying out shearing and/or cutting operations.

The two elastic elements 2 can be any elastic bodies that offer elastic expandability, for example springs, elastic plates, resilient plastics, and rubber.

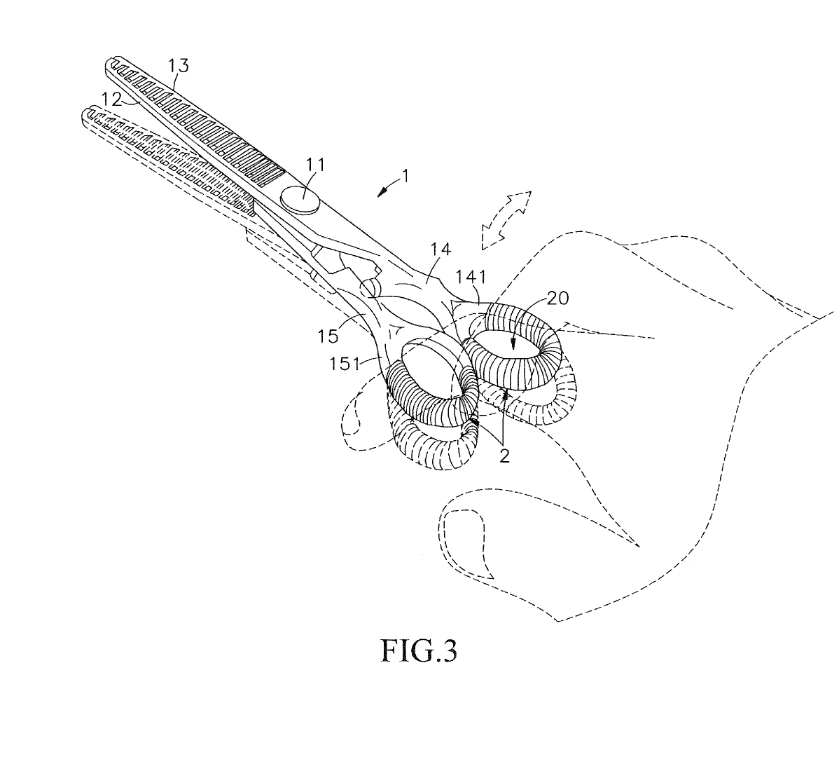

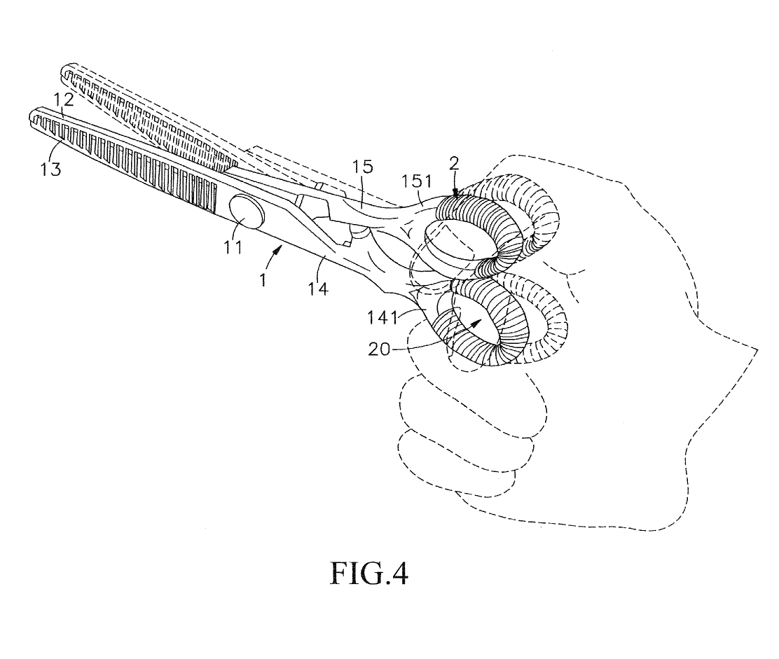

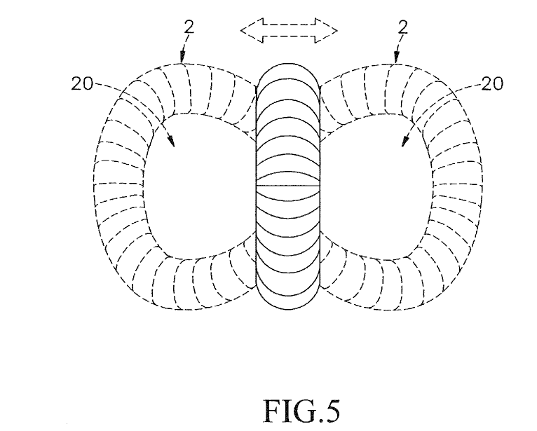

Referring to FIGS. 3-5, which are respectively a perspective view demonstrating leftward and rightward swinging of the body of the scissors according to the present invention, another perspective view demonstrating upward and downward swinging of the body of the scissors according to the present invention, and an end view demonstrating the swinging of the elastic elements, these drawings show that the structure of the scissors according to the present invention, when applied to a shearing/cutting operation, allows for performance of for example hair cutting with the body 1 thereof. In case of fly-cutting, the two finger holes 20 formed between the two holding sections 141, 151 of the body 1 and the two elastic elements 2 respectively receive fingers 3 therein. When the fingers 3 apply a force to cause swinging, shaking, or waving, the fingers 3 depress to drive the two elastic elements 2 in order to make the body 1 inducing elastic swinging, showing waving and shaking in leftward and rightward directions or in upward and downward directions, or in other directions. Further, with the elastic expandability provided by the two elastic elements 2, the reaction forces induced on the two blades 12, 13 in the shearing and cutting operation can be damped and canceled by the stretching caused by the fingers 3 placed in the finger holes 20 so that damages, such as impact and abrasion, are prevented from induced on the fingers 3. Further, with the elastic expandability of the two elastic elements 2, when the force applied at the two holding sections 141, 151 is transmitted through the two handles 14, 15 and the pivot 11 to the two blades 12, 13, sideways shift of the two blades 12, 13 can be eliminated, thereby preventing impact and contact occurring between the two blades 12, 13, and thus eliminating potential risk of damaging the two blades 12, 13 and extending the lifespan of the two blades 12, 13.

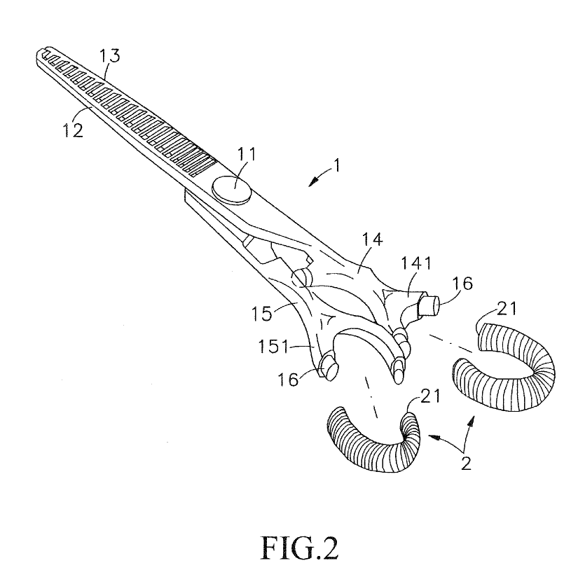

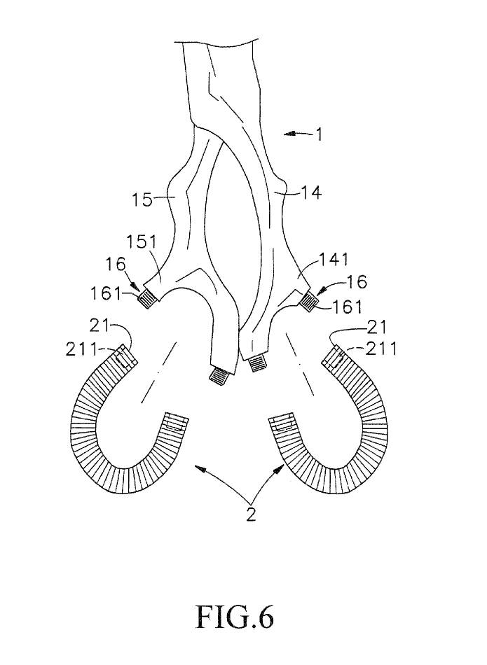

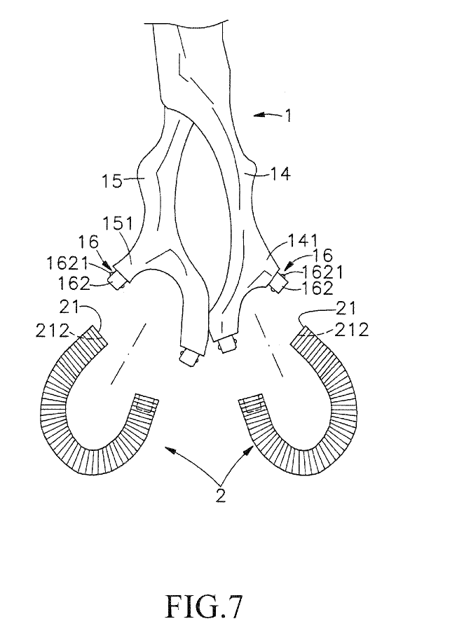

Referring to FIGS. 2, 6, and 7, which are an exploded view of an embodiment of the present invention, an exploded view of a preferred embodiment of the present invention, and an exploded view of a further embodiment of the present invention, these drawings show two holding sections 141, 151 extending from the two handles 14, 15 of the body 1 according to the present invention can be formed as an arc of half a circle, a third of a circle, a quarter of a circle, three quarters of a circle, four fifth of a circle, or other suitable circular arc or curved configurations, for combining with elastic elements 2 of any desired length to form finger holes 20 for receiving fingers of various shapes. The two holding sections 141, 151 of the body 1 each form at two ends thereof connection sections 16, which comprise a structure of assembling in the form of for example raised pillars, internal threading or external threading, clamping projections, for realizing positioning and coupling so that the coupling sections of the two ends of each of the two elastic elements 2 can be attached thereto. The coupling sections 21 formed on the ends of the two elastic elements 2 are formed to correspond to and mate the connection sections 16 of two holding sections 141, 151 by forming a structure of assembling in the form of engaging recesses, external threading or internal threading, or fitting slots for matingly jointing and fixedly coupling with the connection sections. In case the connection sections 16 of the two holding sections 141, 151 are threaded bars 161 that are of external threading, the coupling section 21 of the ends of the two elastic elements 2 are made in the form of internally-threaded holes 211 so that the two elastic elements 2 use the internally-threaded holes 211 of the coupling sections 21 to respectively joint the threaded bars 161 of the connection sections 16 through rotary screwing operation. After the internally-threaded holes 211 of the coupling sections 21 of the two elastic elements 2 are respectively jointed to the threaded bars 161 of the connection sections 16, the two elastic elements 2 are securely coupled to the connection sections 16. In applying rotation in reversed direction to the two elastic elements 2, due to the flexible deformation and shrinking of the two elastic elements 2, it would be hard to loosen the two elastic elements 2 from the connection section 16s. In this way, the two elastic elements 2 are securely attached to the connection sections 16 without easy loosening and detachment.

Alternatively, the connection section 16 of each of the two holding sections 141, 151 comprises a pillar on which a plurality of clamping projections 1621 is formed, and the two coupling sections 21 of the two ends of each of the elastic elements 2 form engaging recesses and/or fitting slots 212, whereby the two elastic elements 2 use the fitting slots 212 formed in the coupling sections 21 to couple the clamping projections 1621 of the pillars 162 of the connection section 16 through fitting and clamping engagement therebetween.

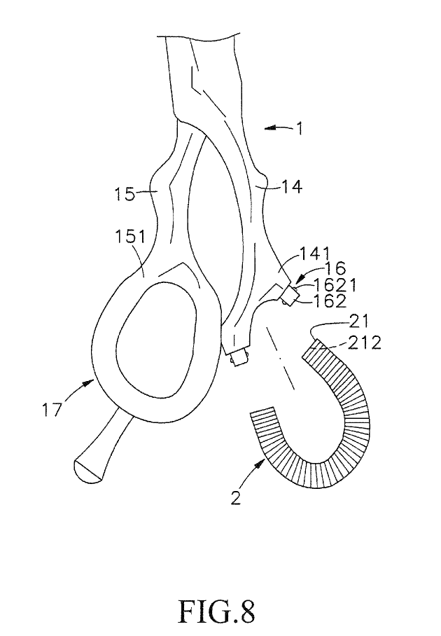

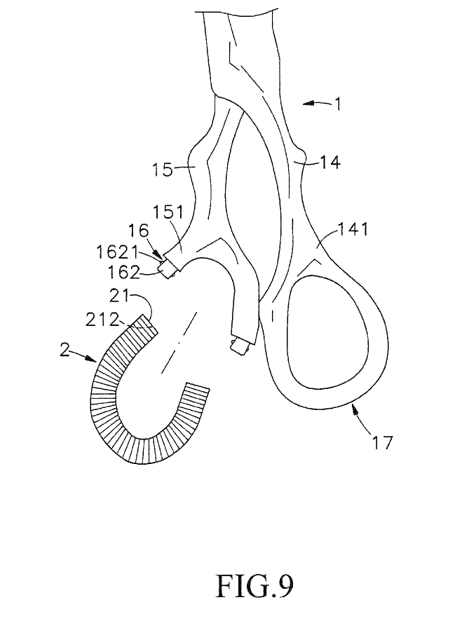

Referring to FIGS. 2 and 7-9, which are an exploded view of an embodiment of the present invention, an exploded view of another embodiment of the present invention, a plan view of a further embodiment of the present invention, and a plan view of yet a further embodiment of the present invention, these drawings show that a structure of scissors according to the present invention comprises a body 1 and at least one or more than one elastic elements 2.

The body 1 of the scissors comprises two blades 12, 13 extending from one side of a pivot 11 and two handles 14, 15 extending from an opposite side of the pivot 11. Further extending from the two handles 14, 15 in a direction away from the pivot are two arc holding sections 141, 151. At least one holding section 141 (or the holding section 151) has two ends each forming a connection section 16.

At least one or more than one elastic elements 2 is an elastic body possessing resilient expandability and stretchability, and having two ends each forming a coupling section 21.

In the body 1 of the scissors according to the present invention, among the two holding sections 141, 151 extending from the two handles 14, 15, the holding section 141 of one handle 14 forms an integrated grip 17, while the holding section 151 of the other handle 15 forms the connection sections 16 for connection with the coupling sections formed on the two ends of the elastic element 2.

Alternatively, the holding section 151 of the handle 15 of the body 1 forms an integrated grip 17, while the holding section 141 of the handle 14 forms the connection sections 16 for connection with the coupling sections 21 of the elastic element 2. This provides “handed” configurations for different uses to hold and use the scissors.

In the coupling sections 21 of the two ends corresponding to the connection sections 16 of at least one holding section 14 (or holding section 15) of the body 1, the elastic element 2 forms engaging recesses, external threading or internal threading, or fitting slots for mating and coupling with the connection sections 16.

This description provides only several embodiments of the present invention and is not intended to limit the scope of the present invention with such embodiments. According to the present invention, a structure of scissors is provided, comprising a body 1, which comprises, at one side, two holding sections 141, 151 made in the form of circular arc and each having two ends forming connection sections 16 for connection with coupling sections 21 formed on two ends of each of two elastic elements 2, whereby between the two holding sections 141, 151 and the two elastic elements 2, two finger holes 20 are formed for receiving fingers 3 to insert therein. Thus, the arrangement of the elastic elements 2 helps providing a cushioning function to conceal the reaction forces induced on the two blades 12, 13 of the body 1 in performing a shearing/cutting operation. When the body 1 is in operation and induces swinging and waving motion, the stretchability and expandability of the two elastic elements 2 help preventing the two holding sections 141, 151 and the two elastic elements 2 from causing damages of impact and abrasion to fingers 3 so that the fingers 3 are protected from being hurt or callusing. Apparently, any structure that shows the advantages and functionality described above are considered within the scope of the present invention and all modification and equivalent structures are considered covered by the true scope of the present invention.

The structure of scissors according to the present invention, when put into practice, shows the following advantages:

(1) The ends of the arc holding sections 141, 151 of the body 1 are respectively to two elastic elements 2 to form two finger holes 20 for receiving fingers 3 to be positioned therein, whereby when the fingers 3 are moved inside the two finger holes 20, they are protected by the cushioning functions provided by the two elastic elements 2 against impact, abrasion, or callusing acting on the fingers 3.

(2) When the body 1 is being used, the reaction forces that are induced by the two blades 12, 13 inside the finger holes 20 formed between the two holding sections 141, 151 and the two elastic elements 2 can be concealed by the elastic expandability of the two elastic elements 2 to thereby eliminate damage caused by the reaction forces on the fingers 3.

Thus, the present invention is provided in relation to the structural arrangement of scissors, in which a body comprises two holding sections each forming connection sections for connection with coupling sections formed on each of two elastic elements, whereby the two holding sections and the two elastic elements form finger holes therebetween for receiving fingers to be positioned therein. Through the elastic expandability provided by the two elastic elements, damages caused by impact of the body on fingers are avoided, wherein in the shearing and cutting operation of the body, the two elastic elements provide a cushioning function that offer the advantages of concealing the reaction forces and protecting fingers from callusing, and also helps smoothening swinging and shaking motions applied in the shearing and cutting operation of the body.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of scissors, which allows for swinging and waving in any direction, comprising a body and two elastic elements, wherein:
the body comprises two blades that are movable for opening and closing at one side of a pivot and two holding sections that drive the two blades to open and close at an opposite side of the pivot, each of the two holding sections having two ends each forming a connection section; and
the two elastic elements are respectively coupled to the two holding sections of the body, and each of the two elastic elements has two ends forming coupling sections that are connectable with the connection sections of the two holding sections.

2. The structure of scissors according to claim 1, wherein the body comprises a structure for assembling in the form of raised pillars, internal threading or external threading, or clamping projections on the connection sections of the two holding sections for connection with the coupling sections of the two elastic elements.

3. The structure of scissors according to claim 2, wherein corresponding to the connection sections of the two holding sections, the coupling sections of the two elastic elements form a structure of assembling in the form of engaging recesses, external threading or internal threading or fitting slots for connection with the connection sections.

4. The structure of scissors according to claim 1, wherein the body comprises two handles extending from said opposite side of the pivot and each of the two handles has an end remote from the pivot and forming each of the two holding sections, the two holding sections being in the form of circular arc, the circular arc holding sections forming at the ends thereof the connection sections.

5. The structure of scissors according to claim 4, wherein the two holding sections are portions that extend from the two handles in a symmetric fashion or asymmetric fashion and are in the form of circular arc of half a circle, a third of a circle, or a quarter of a circle.

6. The structure of scissors according to claim 1, wherein the two holding sections of the body use the coupling sections to connect the two elastic elements so as to form finger holes between the holding sections and the elastic elements for receiving fingers to be positioned therein and wherein with variability in length of the two elastic elements, the finger holes are of size adjustability.

7. The structure of scissors according to claim 1, wherein the two elastic elements elastic bodies in the form of springs, elastic plates, resilient plastics, and rubber that offers elastic expandability.

8. A structure of scissors, which allows for swinging and waving in any direction, comprising a body and at least one or more than one elastic element, wherein:
the body comprises two blades that are movable for opening and closing at one side of a pivot and two holding sections that drive the two blades to open and close at an opposite side of the pivot, the at least one or more than one holding section having two ends each forming a connection section; and
the at least one or more than one elastic element is coupled to at least one of the two holding sections of the body, and the at least one or more than one elastic element has two ends forming coupling sections that are connectable with the connection sections of the at least one of the two holding sections.

9. The structure of scissors according to claim 8, wherein among the two holding sections extending from the two handles of the body, one of the holding sections integrally forms a grip and another one of the holding sections has two ends forming the connection sections for connection with the coupling sections of the elastic element.

10. The structure of scissors according to claim 9, wherein corresponding to the connection sections of the holding section, the coupling sections of the elastic element form a structure of assembling in the form of engaging recesses, external threading or internal threading or fitting slots for connection with the connection sections.
